(19) United States
(12) Patent Application Publication
(10) Pub. No.: US 2025/0039582 A1
(43) Pub. Date: Jan. 30, 2025

(54) TIME-OF-FLIGHT CIRCUITRY AND TIME-OF-FLIGHT READOUT METHOD

(71) Applicant: Sony Semiconductor Solutions Corporation, Atsugi-shi, Kanagawa (JP)

(72) Inventors: Qing DING, Stuttgart (DE); Ye CHEN, Stuttgart (DE)

(73) Assignee: Sony Semiconductor Solutions Corporation, Atsugi-shi, Kanagawa (JP)

(21) Appl. No.: 18/715,130

(22) PCT Filed: Nov. 14, 2022
(86) PCT No.: PCT/EP2022/081781

§ 371 Date: May 31, 2024

(30) Foreign Application Priority Data
Dec. 9, 2021 (EP) 21213281.5

(51) Int. Cl. H04N 25/78; G01S 7/4863

(52) U.S. Cl. CPC H04N 25/78; G01S 7/4863

(57) ABSTRACT

The present disclosure generally pertains to time-of-flight circuitry including: an imaging element; and readout circuitry configured to: apply a plurality of time-shifted readout taps to a plurality of outputs of the imaging element, wherein the time-shifted readout taps are shifted in time with respect to each other, such that the outputs of the imaging element are read out after one another.

### TECHNICAL FIELD

The present disclosure generally pertains to time-of-flight circuitry and a time-of-flight readout method.

### TECHNICAL BACKGROUND

Generally, time-of-flight (ToF) devices for determining a distance to a scene (e.g. area, object, or the like) are known.

For example, it may be distinguished between iToF (indirect ToF) and dToF (direct ToF), which are different in their approach of determining the distance.

In dToF, the distance may be directly measured by measuring a roundtrip delay of a light pulse from emission to detection after it has been reflected at the scene.

For dToF, a plurality of counters may be used which may count multiplied electron signals which are generated based on the (reflected) light being incident on an image sensor. The counters may be time-synchronized, such that a histogram may be generated and the distance may be concluded based on a peak of the histogram.

In iToF, a distance may be measured based on modulation signals. For example, a modulation signal may be used to modulate a light source, such that modulated light is emitted. The modulation signal may be reused and reproduced, such that a plurality of modulation signals may be applied to outputs of the image sensor, wherein the modulation signals may further be phase-shifted. Based on an overlap of the detected, returned modulated light signal with the phase-shifted modulation signals, the distance can be determined.

Although there exist techniques for performing a distance measurement, it is generally desirable to provide time-of-flight circuitry and a time-of-flight readout method.

### SUMMARY

According to a first aspect, the disclosure provides time-of-flight circuitry comprising:
an imaging element; and
readout circuitry configured to:
apply a plurality of time-shifted readout taps to a plurality of outputs of the imaging element, wherein the time-shifted readout taps are shifted in time with respect to each other, such that the outputs of the imaging element are read out after one another.

According to a second aspect, the disclosure provides a time-of-flight readout method comprising:
applying a plurality of time-shifted readout taps to a plurality of outputs of an imaging element, wherein the time-shifted readout taps are shifted in time with respect to each other, such that the outputs of the imaging element are read out after one another.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1A depicts an embodiment of ToF circuitry which is implemented as a spatial multiplexing N-tap sensor;

FIG. 1B depicts an embodiment of a timing diagram of the signals for the ToF circuitry of FIG. 1A;

FIG. 2A depicts an embodiment of ToF circuitry including an imaging element with nine imaging sub-elements, which are based on SPADs;

FIG. 2B depicts an embodiment of a timing diagram for the ToF circuitry of FIG. 2A;

FIG. 3A depicts two embodiments of ToF circuitry for illustrating the principles of a temporal multiplexing N-tap sensor;

FIG. 3B depicts an embodiment of a timing diagram for the right ToF circuitry of FIG. 3A;

FIG. 4A depicts an embodiment of ToF circuitry with a plurality of counters;

FIG. 4B depicts an embodiment of a timing diagram for the ToF circuitry of FIG. 4A;

FIG. 4C depicts an embodiment of a histogram which is generated based on the ToF circuitry of FIG. 4A.

FIG. 5A depicts an embodiment of ToF circuitry including a plurality of bidirectional counters;

FIG. 5B depicts an embodiment of a timing diagram for the ToF circuitry of FIG. 5A;

FIG. 5C depicts an embodiment of a timing diagram for the counters of FIG. 5A;

FIG. 5D depicts an embodiment of a delta histogram which is generated based on the ToF circuitry of FIG. 5A;

FIG. 6 depicts a ToF readout method according to the present disclosure, in which the plurality of readout taps is applied to a plurality of imaging sub-elements;

FIG. 7 a further embodiment of a ToF readout method according to the present disclosure, in which the plurality of time-shifted readout taps is applied to a plurality of capacitances of an imaging element;

FIG. 8 depicts a further embodiment of a ToF readout method according to the present disclosure, in which the plurality of time shifted readout taps is applied to a plurality of counters;

FIG. 9 depicts a further embodiment of a ToF readout method according to the present disclosure, in which a histogram is generated based on the plurality of counters; and

FIG. 10 illustrates an embodiment of a ToF imaging system.

### DETAILED DESCRIPTION OF EMBODIMENTS

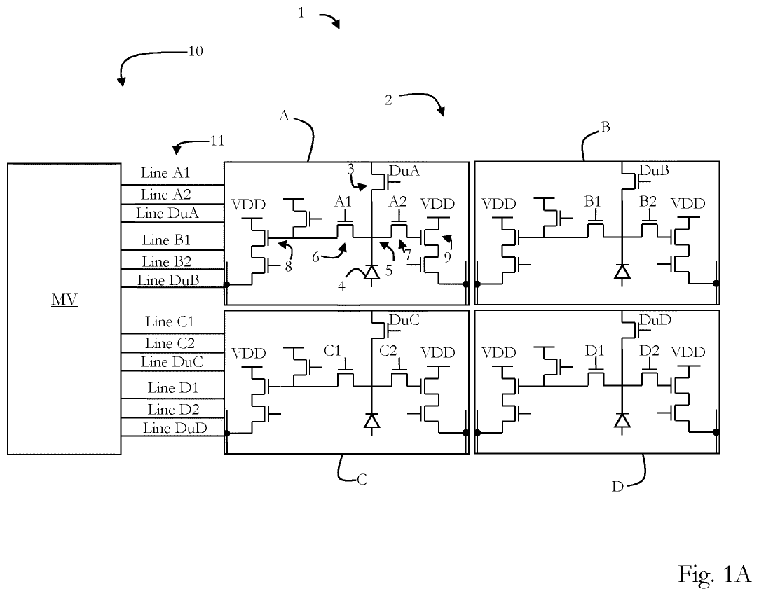

Before a detailed description of the embodiments starting with FIG. 1 is given, general explanations are made.

As mentioned in the outset, ToF devices are generally known. However, it has been recognized that, in order to improve a trade-off between signal to noise ratio (SNR) and a de-aliasing range (in iToF), N-tap operation may be utilized.

N-tap operation may refer to using a plurality of taps (e.g. eight or more (or less)) instead of two-taps, as it is known for iToF, such that an iToF sensor may be comparable to a dToF sensor in terms of SNR under high ambient light.

However, N-tap is not limited to the iToF case since the principles of the present disclosure may also be applied to dToF sensors or dToF readout circuitry, e.g. by detecting pulsed light is detected based on modulation signals or taps.

Moreover, it has been recognized that it is desirable to reduce/mitigate tap mismatch, e.g. by using a charge circulation technique or by using a plurality of taps in one pixel as it will be described herein.

It has further been recognized that it is desirable to increase a dynamic range (and/or area efficiency), save silicon area by using less bit width counters, e.g. based on a delta counting technique, as will be described herein.

Generally, the principles of the present disclosure may be described for being applied to stacked sensor configurations (e.g. where a photo-sensor layer and readout/modulation circuitry may be on separate wafers), but the principles of the present disclosure may be adapted accordingly for non-stacked configurations, if necessary.

Moreover, it has been recognized that it is desirable to provide N-tap sensors with a lower design complexity by implementing N-tap in a spatial or time multiplexing way in analog or digital based circuits, such that also mature iToF or dToF technology may be used.

Therefore, some embodiments pertain to time-of-flight circuitry including: an imaging element; and readout circuitry configured to: apply a plurality of time-shifted readout taps to a plurality of outputs of the imaging element, wherein the time-shifted readout taps are shifted in time with respect to each other, such that the outputs of the imaging element are read out after one another.

The ToF circuitry may include further elements than the imaging element and the readout circuitry, but for carrying out the principles of the present disclosure, these two elements may be sufficient.

For example, corresponding connections and electronic elements, and the like may be envisaged according to the usual skills of the skilled person.

The imaging element may be based on any imaging technology suitable for carrying out a ToF measurement, such as diode technology, gated technology, demodulation technology, or the like. Accordingly, the imaging element may be based on at least one of a SPAD (singe photon avalanche diode), APD (avalanche photodiode), CAPD (current-assisted photonic demodulator), gated ToF pixel, photon multiplier, or any other imaging element with an (inherent) electron multiplying function or gain, or the like.

The imaging element may include a plurality of outputs corresponding to readout taps.

For example, if the imaging element is based on diode technology (wherein the present disclosure is not limited to SPADs and ADPs since any diode or electron multiplication technology may be envisaged, based on which photons may be counted), the outputs may refer to connections which include or which can be connected to photon counters or registers.

In another example, if the imaging element is based on CAPDs or gated technology, the outputs may correspond to gates or taps (with a specific doping, as it is generally known).

Accordingly, the readout circuitry may be any circuitry which can be used for reading out such outputs, i.e. to apply readout taps, such as a CPU (central processing unit), GPU (graphics processing unit), FPGA (field-programmable gate array), any type of integrated circuit (IC), or the like, wherein also multiple of such entities, also in combination, may be envisaged using corresponding interfaces, and the like.

According to the present disclosure, a plurality of readout taps may be applied to the outputs of the imaging element. In some embodiments, readout tap refers to a functional entity and may thus, not be limited to taps of a CAPD, for example. In some embodiments, a readout tap refers to a signal, which is applied to the respective output for reading out from the output.

As indicated above, the readout taps may be time-shifted to each other. For example, each readout tap may be applied after another with a predetermined time (interval) in between the application of each readout tap. The predetermined time may be different between each of the readout taps or may be (roughly) the same between each readout tap.

In some embodiments, the time-shift between the readout taps is equal for each readout tap. However, in some embodiments, the time-shift does not need to be equal.

In some embodiments, a readout tap is applied after a predetermined time in which a previous readout tap is not applied anymore.

In some embodiments, a readout tap is applied immediately after a previous readout tap.

Hence, in some embodiments, the time-shifted readout taps are shifted in time with respect to each other, as indicated above, wherein different types of applying the readout taps “with respect to each other” may be envisaged, as discussed above.

Moreover, in some embodiments, in the time-shifted readout taps are shifted such that the outputs of the imaging elements are read out after one another.

For example, a first (electric) charge (e.g. electrons, holes, electron-hole-pairs or the like) may be collected (from or in the imaging element) for the first output (either within the first output or in a predetermined region for the first output). After the first charge is collected and read, a second charge is collected and read, and so on.

In some embodiments, charges may be collected simultaneously in the outputs, such that, when the readout taps are applied after one another (e.g. without overlapping in time), the outputs and thus, the charges can be read after one another.

In some embodiments, the charges may be generated in the same region of the imaging element (e.g. a photosensitive area) and a corresponding readout tap may cause the charges to be drawn towards the respective output. Hence, if the readout taps are time-shifted, such that they do not overlap, a first charge which is generated for a first time interval is read with the first readout tap, a second charge which is generated for a second time interval (after the first time interval) is read with the second readout tap, and so on.

In some embodiments, a number of the plurality of readout taps corresponds to a number of the plurality of outputs, but these numbers may also be different.

For example, if every output should be read by the readout circuitry, the number of readout taps should be at least as high as the number of outputs. These numbers may be equal, but the number of readout taps may as well be higher than the number of outputs. For example, it may be envisaged that (one or) some certain outputs or all outputs are read with more than one readout tap (e.g. in a demodulation manner as known from iToF, or for any other reason), the number of readout taps may be correspondingly higher than the number of outputs.

However, it may be envisaged that not every output is read by the readout circuitry for different reasons. For example, an output may be defect, such that it cannot be read. In a case of multiple imaging sub-elements establishing one imaging element (e.g. a macro pixel), not every output needs to be read. This may be the case, for example, in a low resolution mode or when the ToF circuitry is driven in any other imaging mode.

On the other hand, even if not every output should be read by the readout circuitry, the number of readout taps can still be equal or higher than the number of outputs for similar reasons as given above, such as a readout of multiple outputs with more than one readout tap, or the like.

Depending on how the present disclosure is implemented, the skilled person may appreciate that “time-shifted” may also refer to “phase-shifted” in some embodiments. Whether the readout tap is time-shifted or phase-shifted may depend on which circuitry or which signal is used in practice.

In some embodiments, the imaging element includes a plurality of imaging sub-elements, as discussed herein.

For example, a predetermined number of imaging sub-elements may be connected, such that they can be read out according to the present disclosure. For example, four two-tap pixels (e.g. based on CAPDs) may be used and each tap may correspond to an output of the macro pixel., without limiting the present disclosure in that regard since any number of outputs and imaging sub-elements may be used.

As an exemplary embodiment, eight outputs may be used, which will further be described with reference to FIG. 1

FIG. 1A depicts ToF circuitry 1 according to the present disclosure including an imaging element 2 and readout circuitry 10. The ToF circuitry 1 is implemented as a spatial multiplexing N-tap sensor with N/2 number of two-tap pixels with one dumping node in each pixel.

In this embodiment, the imaging element 2 includes four imaging sub-elements A, B, C, and D which all are two-tap ToF pixels.

Each of the imaging sub-elements A to D include dump nodes DuA, DuB, DuC, and DuD and collection nodes A1, A2, B1, B2, C1, C2, D1, and D2. The dump nodes DuA to DuD include a transistor 3 which is connected, with its gate, to the readout circuitry. With another node, the transistor 3 is connected to a photodiode 4. Moreover, via a node 5, the transistor 3 and the photodiode 4 are connected with transistors 6 and 7, whose gates are the respective collection nodes A1 to D2.

However, none of the transistors mentioned in this specification is limited to a specific type. For example, an NMOS transistor may be used for the timing diagram of FIG. 1B. However, the transistor may be any type of transistor or may include different types of doping, such as PMOS in which case the polarity of the signals in FIG. 1B may be reversed.

Moreover, with the respective other node, the transistors 6 and 7 are connected to gates of further transistors 8 and 9 which are biased with a voltage VDD.

Accordingly, the two-tap pixels A to D can be controlled such that, if a signal is applied to a dumping node DuA to DuD, a current generated in the photodiode 4 is drawn towards the respective dumping node DuA to DuD. If a signal is applied to the collection nodes A1 to D2, a current in the photodiode is drawn towards the respective collection nodes A1 to D2.

Signals are applied by the readout circuitry 10 via respective signal lines 11 connected to the collection nodes A1 to D2 or to the dump nodes DuA to DuD. For example, Line A1 is connected to the collection node A1, line DuB is connected to the dump node DuB, and so on.

The readout circuitry 10 further includes a signal generator MV (short for modulation clock generator and driver) which is configured to generate the respective signals.

FIG. 1B depicts a timing diagram 15 of the signals which are applied via the signal lines 11 to the respective nodes (dumping nodes DuA to DuD and collection nodes A1 to D2.

Generally, if an imaging sub-element of the imaging sub-elements A to D should not be read out, the voltage applied to the respective dumping node DuA to DuD is high (or logical one), and if the respective imaging sub-element should be read out, the voltage applied to the respective dumping node DuA to DuD is low (or logical zero). As mentioned above, if a different transistor is used, the signals may be altered or even reversed.

In this embodiment, the imaging elements A to D are read out after each other. Moreover, the collection nodes A1 to D2 are read out after each other.

Hence, at a first point of time, when nothing is read, the signals on the dumping nodes DuA to DuD is high and the signals on the collection nodes A1 to D2 is low. When a readout starts, a signal at the first dumping node A1 is high while at the same time, the signal on the dumping node DuA is set low.

After a predetermined signal width, the signal on A1 is set low again and immediately after that, the signal on A2 is set high for the predetermined signal width. When A2 is set low again, DuA is set high again and DuB is set low. At the same time, for the predetermined signal width, B1 is set high. After B1 is set low, B2 is set high for the predetermined signal width. After that, DuB is set high again, and DuC is set low, such that C1 and C2 are set high after each other for the predetermined signal width. After C2 is set low again, DuC is set high again and DuD is set low, such that D1 and D2 are set high after each other for the predetermined signal width. After that, DuD is set high again.

In this embodiment, all collection nodes A1 to D2 are read out for the same predetermined amount of time, but the readout time for each collection node may be adapted accordingly and may be different, for example, when different photodiodes (with different quantum yields) are used or when the imaging sub-elements have different elements, or based on a calibration.

Moreover, the timing diagram 15 only shows a fraction of a whole modulation pattern and may be adapted or changed according to the circumstances. The pattern may be repeated in a train throughout a whole exposure, during which the micro-pixels (or imaging sub-elements) collect photo-electrons (i.e. when the respective dump node (or dump gate) is low).

The implementation shown in FIG. 1 uses two-tap technology which is generally known. Hence, known imaging sub-elements may be used and it may be sufficient to only adapt the readout and the readout circuitry. Moreover, a modulation speed is optimized since the imaging sub-elements may be based on mature CIS (CMOS image sensor) technology and since the respective outputs (taps) may be provide in close proximity to each other.

Moreover, in some embodiments, a mismatch/offset of the respective readout circuits may be mitigated when the readout circuits include shared source followers, which may be shared for all the taps in one macro-pixel (imaging element, in this embodiment).

Furthermore, the present disclosure is not limited to any number of imaging sub-elements, such as the four imaging sub-elements of FIG. 1.

In some embodiments, each sub-element includes at least one output. In the above example, each imaging element has two outputs, but different types of imaging elements with different types of outputs may be used according to the present disclosure and the outputs may be controlled accordingly.

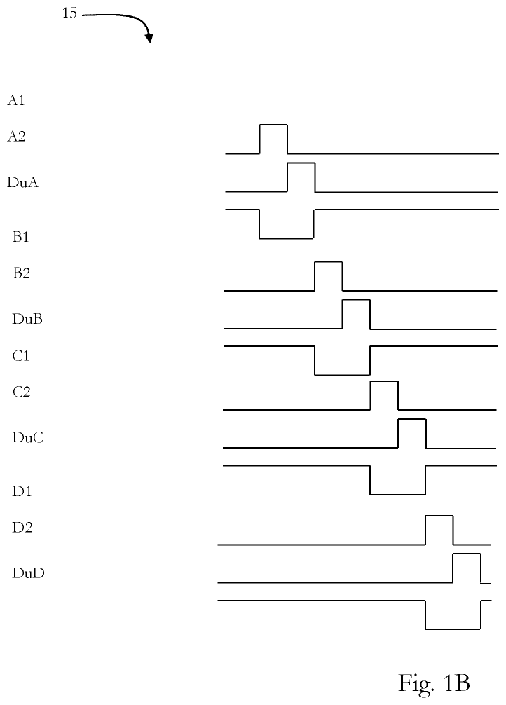

FIG. 2A depicts an embodiment of ToF circuitry 20 including an imaging element 21 with nine imaging sub-elements 22 each having one output 23 which, wherein the output 23 is implemented as a pulse generator. The nine imaging sub-elements 22 are arranged as a three times three pixel array.

Each imaging sub-element further includes a SPAD 24 (single photon avalanche diode), and a counter 25.

The ToF circuitry 20 further includes ToF readout circuitry 26 including a signal generator MV and signal lines 27. There are three signal lines 27 of which each is connected to imaging sub-elements of each row of the pixel array. Hence, a signal line G[0:2] is connected to the outputs 23 of the first row, a signal line G[3:5] is connected to the outputs 23 of the second row, and a signal line G[6:8] is connected to the outputs 23 of the third row. Hence, via the line G[0:2], modulation signals G[0], G[1], and G[2] can be applied to the outputs of the first row, wherein the signal G[0] is applied to the first pixel of the row, G[1] is applied to the second pixel of the row, and G[2] is applied to the third pixel of the row. Correspondingly, via signal line G[3:5], modulation signals G[3], G[+], and G[5] can be applied to the first, second, and third pixel of the second row, and via signal line G[6:8], modulation signals G[6], G[7], and G[8] can be applied to the first, second, and third pixel of the third row.

When a modulation signal is applied to the respective pulse generator or output 23, if an avalanche signal is generated in the SPAD 24, the respective counter 25 is increased. When the outputs 23 driven after each other, a counting result of the different counters 25 can be associated with a respective time bin.

FIG. 2B depicts a timing diagram 28 according to which the signals G[1] to G[8] are applied to the outputs 23. To such embodiments, it may also be referred to as spatial multiplexing.

As can be taken from the timing diagram 28, before a readout phase starts, signals G[1] to G[8] are set low. Then, the signal G[0] is set high for a predetermined amount of time and then set low again. After that, the signal G[1] is set high for the predetermined amount of time and then set low again. The same applies to the remaining signals G[2] to G[8] which are all applied immediately after one another.

Hence, in this embodiment, a similar pattern as in FIG. 1 is applied and thus, N-tap operation is realized in a SPAD-based imaging element.

Spatial multiplexing using mosaics has been described with respect to the exemplary embodiments of FIGS. 1 and 2. In such embodiments, a layout of a macro pixel may include multiple (sub-) pixels in a mosaic way, in which each of the (sub-) pixels may correspond to at least one tap in an N-tap sensor individually, and thus may operate in turns to resolve incident light of a corresponding phase. The (sub-) pixels may be based on an active pixel device or other devices, such as 3T, 4T, SPAD, APD, or the like.

A mosaic may refer to multiple pixels being used together. However, these may not necessarily be neighboring pixels as any mosaic pattern may be envisaged depending on the circumstances.

In case a tap is non-addressed, but generates a signal, such a signal may be disposed, for example.

In some embodiments, the plurality of outputs corresponds to a plurality of capacitances of the imaging element.

For example, different regions of the imaging element may cause a capacitance to be existent with respect to another region. For example, if the ToF circuitry is provided in a semiconductor, different doped regions (as outputs) may be provided in which charges may be collected and read via the readout taps, which may be applied to the different doped regions. The doped regions may be symbolically represented by a capacitor since they may constitute a parasitic capacitance with another layer (e.g. a readout layer) of the semiconductor. However, depending on how the ToF circuitry is implemented, “real” capacitors may be used, as well.

In some embodiments, the plurality of time-shifted readout taps is applied to the plurality of capacitances based on a main readout capacitance to which each time-shifted readout signal is applied, and based on a plurality of sub-capacitances which each are read out with one respective time-shifted readout signal of the plurality of time-shifted readout signals.

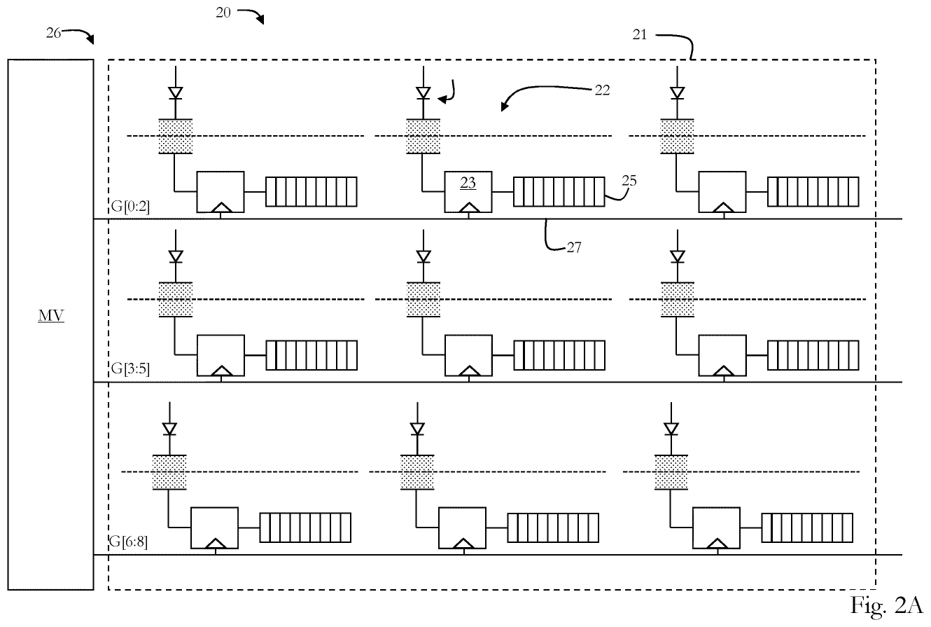

For illustrating such embodiments, in the following, it is referred to FIG. 3.

FIG. 3A depicts two embodiments for which temporal multiplexing may be carried out. Temporal multiplexing may refer to a sharing of one imaging element by multiple readout nodes. On the left side of FIG. 3A, passive ToF (integrator) circuitry 30 is shown. The ToF circuitry 30 includes an imaging element 31 including a photodiode and an analog modulator 32, wherein the analog modulator further includes a storage element and a charge circulation circuit (not shown).

Moreover, readout circuitry 33 for reading out the analog modulator 32 with multiple outputs is provided.

The readout circuitry 33 is connected, with a gate of a transistor 34, to the analog modulator 32. The transistor 34 is further connected to a voltage VDD and to a further transistor 35.

Moreover, a further transistor 36 is connected with the gate of the transistor 34 and the analog modulator 32.

On the right side of FIG. 3A, readout circuitry 40 is depicted which is implemented as a single-ended capacitive transimpedance based active integrator with N-memory elements, wherein the readout circuitry 40 acts as both an integration element and a circulation element.

The readout circuitry 40 is connected to a capacitor 41 which couples the readout circuitry 40 with an imaging element (not shown).

The readout circuitry 40 includes an operational amplifier 42, which is connected, with one input node, to a reference voltage V_ref, and, with another input node, to a capacitor 43 and to a reset switch (RST) 44, which is in turn connected to the output of the operational amplifier 42.

Moreover, the output of the operational amplifier 42 is connected to a switch SH which, when closed, establishes a connection of the readout circuitry 40 with the capacitor 41.

The readout circuitry 41 further includes five sub-circuits 45. It should be noted that the present disclosure is not limited five sub-circuits 45 since this is only an exemplary embodiment and any number of sub-circuits may be envisaged. Moreover, it should be noted that, although five sub-circuits are shown, the present embodiment includes eight sub-circuits, and five are only shown for illustrational purposes.

Each sub-circuit 45 includes a capacitor 46 which is connected to the capacitor 43, such that the sub-circuit 45 is coupled to the input of the operational amplifier 42.

Moreover, the sub-circuit 45 includes two parallel signal lines 47 and 48 which are connected to (the other side of) the capacitor 46.

The signal line 47 includes a switch GD and is connected to the output of the operational amplifier 42. The switch GD is symbolic for a plurality of switches whose timing will further be discussed under reference of FIG. 3B and which will be enumerated accordingly as GD1 to GD8.

The signal line 48 includes a switch SWGND and is connected to the reference voltage V_ref. The switch SWGND is symbolic for a plurality of switches whose timing will further be discussed under reference of FIG. 3B and which will be enumerated accordingly as SWGND1 to SWGND8.

If the switch SH is closed, a readout can be carried out according to the following exemplary embodiment, which is discussed under reference of FIG. 3B.

FIG. 3B depicts a timing diagram 50 according to which the readout circuitry 40 can be driven. In the following, when a high signal (or logical one) is applied, a respective switch of the readout circuitry 40 is closed, and when a low signal (or logical zero) is applied, the respective switch of the readout circuitry 40 is open.

In a reset phase 51, all nodes are reset to reset voltage by a high signal 52 applied to the switches RST 44 and GD1 to GD7 (which correspond to the switch GD of FIG. 3A, but are enumerated to distinguish between the sub-circuits 45).

Moreover, a high signal 53 is applied to the switch GD8 (which is the main switch for the main capacitance, in this embodiment), wherein the high signal 53 is longer than the high signal 52 and extends into an integration phase 55.

During the integration phase, a modulation pattern is applied which is similar to the modulation pattern discussed under reference of FIG. 2B, i.e. after each other each switch is closed for a predetermined amount of time. However, contrary to FIG. 2B, the switch GD8 is closed for a longer time than the switches GD1 to GD7 since GD8 is used as a dump node (or dump tap). After that, the modulation pattern repeats until a predetermined number of modulation cycles have been carried out.

A signal of the switches SWGND1 to SWGND8 is kept low during the reset phase 51 and the integration phase 55.

After the integration phase 55, the dump node GD8 is reset by applying a high signal to RST 44 and keeping the signal high on GD8 during a dump node reset phase 56. The remaining signals are kept low, i.e. all the other switches are kept open.

After the dump node reset phase 56, RST 44 is set low again, but GD8 is kept high. This phase is also referred to as charge circulation phase. According to the present disclosure, a plurality of charge circulation phases carried out, in which each node is read out after one another.

In a first charge circulation phase 57, charge is transferred from GD7 to GD8 and is drawn out of GD8 since GD8 is still high (i.e. closed). Moreover, SWGND7 is set high, but GD7 is set low, such that the charge can flow from GD7 to GD8.

After the first charge circulation phase 57, a second charge circulation phase 58 is carried out in which charge flows from GD6 to GD7 by setting GD7 high and SWGND6 high. The same applies to GD5, whose charge is transferred to GD6, and so on. After all switches (or tabs) carried out one charge transfer, a new integration phase starts, with the modulation pattern on GD also mismatched by 1 tab from the first integration period. The combination of integration and charge transfer period repeats N times (N equal the number of tabs excluding the dump node, i.e. eight times in this embodiment) or an integral of N times.

Such a charge circulation may be used to even out a transfer speed mismatch between a photodiode and different capacitors.

After this operation, all the tabs are read out, starting with charge circulation 57, i.e., charge is transferred from GD7 to GD8 for readout. After the first charge circulation phase 57, a second charge circulation phase is carried out in which charge flows from GD6 to GD7 by setting GD7 high and SWGND6 high, and so on. After that, the first charge circulation phase 57 is carried out again to read the charge from GD8. The same applies to GD5, whose charge is transferred to GD8 in a similar way, and so on.

The charge circulation discussed above may be used to ensure that the readout is carried out on one tab to remove an offset of readout voltage due to capacitance mismatch, for example.

In this embodiment, a capacitive transimpedance amplifier CTIA is used for both integration and charge circulation, but if it used for charge circulation only, only the timing of the reset, the charge circulation and the readout phase may be relevant.

In some embodiments, each capacitance is coupled to at least two readout switches, as discussed herein.

Under reference of FIG. 3, temporal multiplexing has been described. In this non-limiting example, N-tap operation is implemented by N analog integrators or N counter elements sharing the same pixel device. In such embodiments, no pixel mismatch may exist because only one pixel device may be used for several taps.

In analog implementations, N memory elements may be realized by N integration capacitors and switching operations between the capacitors may be realized by analog switches. In counting implementations, the N memory elements may be realized by N counters and switching operations between the capacitors may be realized by a multiplexer.

In some embodiments, the plurality of outputs corresponds to a plurality of counters. The counters represent the plurality of outputs or plurality of taps, in some embodiments.

For example, a first counter (as it is known from dToF), may count photons for a first time interval, a second counter may count photons for a second time interval, and so on.

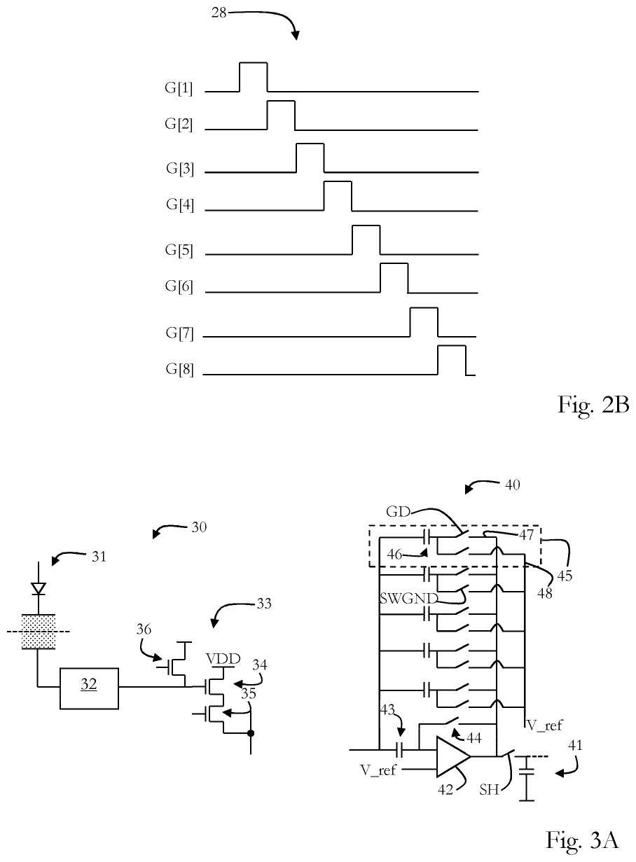

The counters may be timed based on corresponding circuitry which is in the following discussed with respect to FIG. 4.

FIG. 4A depicts ToF circuitry 60 including a SPAD 61, which transfers charge to a pulse generator 62. When the pulse generator detects an avalanche signal from the SPAD 61, a pulse is generated and transmitted to a multiplexer 63.

A control line 64 is connected to the multiplexer 63, such that a respective counter of counters 65a, 65b, 65c, and 65x (wherein x represents an arbitrary number, i.e. the present disclosure is not limited to four counters as displayed in FIG. 4A) is driven by the multiplexer 63 according to a modulation signal transmitted by the control line 64.

FIG. 4B shows a timing diagram 66 according to which the multiplexer 63 drives the counters 66.

Similar to the modulation pattern of FIG. 2B, different modulation signals a, b, c, and x (wherein again, x stands for an arbitrary number and the letters used herein correspond to the letters used for the counters 65a, 65b, 65c, and 65x) are applied sequentially. The upper counter 65a is increased when a pulse from the pulse generator 62 is generated simultaneously with the upper modulation signal being high. Accordingly, the second counter 65b from above is increased when a pulse from the pulse generator 62 is generated simultaneously with the second modulation signal from above being high, and so on.

Hence, according to the timing diagram 66 of FIG. 4B, multiplexer control signals are generated in a way that multiplexes the output of the image SPAD 61 to a corresponding tap temporally.

The multiplexer is not limited to any specific element and may be implemented based on NAND gates, AND gates, transmission switches, or the like.

Based on the counters, a histogram 67 may be generated, as shown in FIG. 4C based on which depth generation can be determined, as it is generally known.

Hence, in some embodiments, a histogram is generated based on counts in the plurality of counters, as discussed herein.

Under reference of FIG. 4, a non-limiting example of a DEM (dynamic element matching) technique has been discussed. For example, mismatch cancellation techniques with tap circuit/charge circulation may be carried out by analog integrators. In such embodiments, N-tap may be implemented by an N-tap pixel concept, such as a gated pixel (with N gates), or with another pixel which is modulated with an analog integrator. For reducing an offset, charge may be caused to circulate through an analog memory component of the integrator(s) while a laser phase may change correspondingly.

In some embodiments, the counters are bidirectional counters.

If bidirectional counters are used, less silicon space may be occupied by the counters since histograms may be less complex. Accordingly, in some embodiments, a histogram is generated based on counts in the bidirectional counters, wherein entries of the histogram correspond to relative counts with respect to their respective neighboring entry.

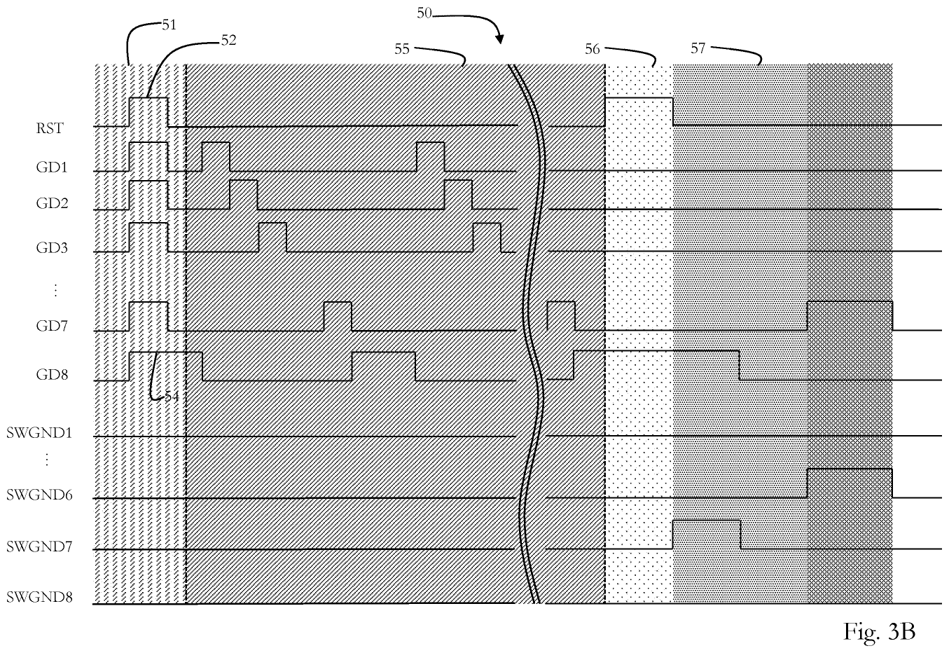

Referring now to FIG. 5, ToF circuitry with bidirectional counters and a timing thereof is described.

In FIG. 5A, there is shown ToF circuitry 70 including a SPAD 71 which is connected to a pulse generator 72. In response to a signal from the SPAD 71, the pulse generator 72 is configured to generate a pulse which is transmitted to a multiplexer 73. The multiplexer is controlled by ToF readout circuitry according to the present disclosure, such that the pulse is only transmitted to a predetermined counter according to a modulation signal or a readout tap, as discussed herein. Accordingly, the ToF circuitry further includes a plurality of bidirectional counters 74.

In contrast to the counters 65 of FIG. 4A, the bidirectional counters 74 of the present embodiment occupy less silicon space since delta counting can be carried out with them, such that fewer counting values need to be saved.

For carrying out delta counting, the bidirectional counters 74 are signed and work in a repetitively circular way.

For an n-th tap, a corresponding counter n is configured to accumulate the counts from the SPAD 71 in a positive or negative direction while the counter n-1 counts in the opposite direction. Hence, one counter is configured to handle a differential signal value of two adjacent taps and partial ambient light count value.

Moreover, adders 82 are provided which each connect one output of the multiplexer 75 to two adjacent counters (instead of one counter as in FIG. 4A). The adder may be any type of adder, such as a digital OR-gate, or the like.

FIG. 5B depicts a timing diagram 75 of a plurality of taps which are applied to the multiplexer 73. The taps 75 are, similar to FIG. 2B, based on time-shifted modulation signals which are applied after each other to different switches 76 within the multiplexer 73, such that a pulse from the pulse generator 72 is transmitted to a respective counter 74 which is connected to the respective switch 76.

FIG. 5C depicts a timing diagram 77 according to which the counters 74 are configured to count. The timing diagram includes a plurality of time-shifted modulation signals 78 which are applied after each other. The time-shifted modulation signals 78 are reused taps 75 (or multiplexer control signals).

If a high region 79 of a modulation signal 78 for the respective counter overlaps with a pulse of the pulse generator 72, the counter 74 is configured to count up (i.e. plus one, without limiting the present disclosure in that regard). If a low counting region 80 of the modulation signal 78 overlaps with a pulse, the counter 75 is configured to count down (i.e. minus one, without limiting the present disclosure in that regard). The modulation signals 78 further include a region 81 in which no counting is carried out (to which it is also referred to as “sign no care region”). The region 81 overlaps with a high region of the modulation signal of a neighboring counter, such that delta counting can be carried out.

FIG. 5D depicts a delta histogram 85 (on the right) which is generated based on the ToF circuitry 70. On the left, the histogram 67 of FIG. 4D is shown for comparing the two histograms. Additionally, on the second bar from the left of the histogram 67, a differential value bar 86 between the first bar and the second bar is shown which is representative of a differential value between the first and the second bar of the histogram 67.

Since the second bar is lower than the first bar, the differential value is negative. Hence, this differential value is drawn as a negative second value of the delta histogram 85 on the right. The first bar of the histogram 85 derives in a similar way based on a comparison of the first bar to the last bar. It should be noted that according to the embodiment of FIG. 5, it is not necessary to generate the histogram 67 and based on that, generate the delta histogram 85 since the ToF circuitry 70 is configured to generate the delta histogram 85 directly.

In the delta histogram 85, two peaks are depicted. Since a delta counting is carried out, at least two peaks are visible every time a ToF measurement is carried out, wherein the two peaks are signed, i.e. one is positive and another one is negative.

Based on the delta histogram 85, the histogram 67 may as well be reconstructed without common mode counts. Alternatively, based on the two peaks, a location of a peak may be concluded directly based on a flip of large delta count values with different signs between two counters. The remaining bins are small values (i.e. below a predetermined threshold) since common mode counts may either be already subtracted or may have never been counted in the first place. In above embodiment, the peak is located at the sixth bin seen from the left.

Under reference of FIG. 5, a non-limiting example of a delta counting circuit and method has been described. In such a configuration, a smaller size of a macro cell may be needed compared to the embodiment of FIG. 4 since less unit cells or counting elements may be required due to the smaller size of the histogram. Hence, the embodiment of FIG. 5 may be more area efficient.

Generally, delta counting may refer to storing differences between two adjacent taps instead of storing raw counting values. As discussed above, signed bidirectional counter may be used without limiting the present disclosure in that regard. All the counters may work in turns, but two adjacent counters may be enabled simultaneously while one of the two adjacent counters may count up and the other one may count down.

The counters may be adapted to handle a differential signal value of two adjacent taps and a clipped ambient light value (i.e. the ambient light value may not be taken into account since it may be immediately subtracted during exposure due to the delta counting), such that, in total, counter area is saved in contrast to counters which are only adapted to store the light signal and the ambient light during a whole exposure time.

Some embodiments pertain to a time-of-flight readout method including: applying a plurality of time-shifted readout taps to a plurality of outputs of an imaging element, wherein the time-shifted readout taps are shifted in time with respect to each other, such that the outputs of the imaging element are read out after one another, as discussed herein.

The ToF readout method may be carried out with ToF circuitry and/or ToF readout circuitry according to the present disclosure.

In some embodiments, the imaging element includes a plurality of imaging sub-elements, as discussed herein. In some embodiments, each sub-element includes at least one output, as discussed herein. In some embodiments, the plurality of outputs corresponds to a plurality of capacitances of the imaging element, as discussed herein. In some embodiments, the plurality of time-shifted readout taps is applied to the plurality of capacitances based on a main readout capacitance, which is read out with each time-shifted readout signal, and based on a plurality of sub-capacitances which are read out with one time-shifted readout signal of the plurality of time-shifted readout signals, as discussed herein. In some embodiments, each capacitance is coupled to at least two readout switches, as discussed herein. In some embodiments, the plurality of outputs corresponds to a plurality of counters, as discussed herein. In some embodiments, a histogram is generated based on counts in the plurality of counters, as discussed herein. In some embodiments, the counters are bidirectional counters, as discussed herein. In some embodiments, a histogram is generated based on counts in the bidirectional counters, wherein entries of the histogram correspond to relative counts with respect to their respective neighboring entry, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

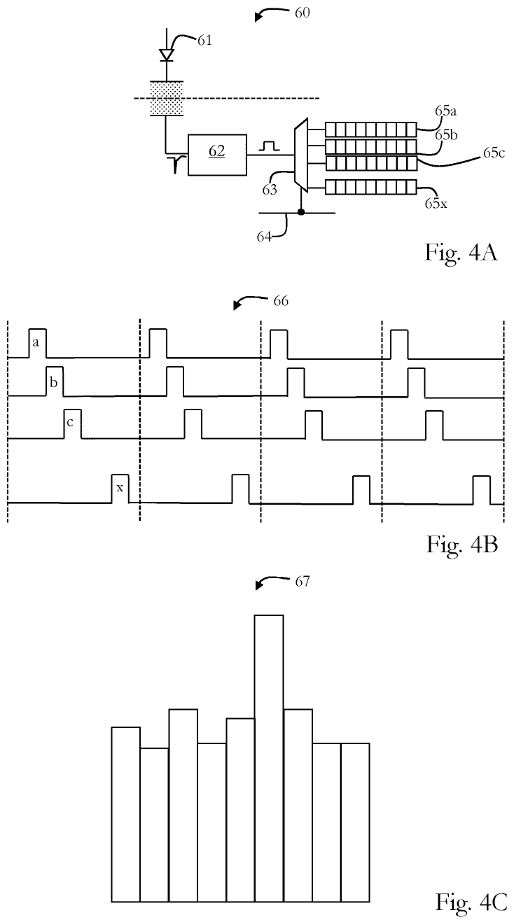

FIG. 6 depicts a ToF readout method 90 according to the present disclosure, in which the plurality of readout taps is applied to a plurality of imaging sub-elements.

Thus, at 91, a plurality of time-shifted readout taps is applied to a plurality of imaging sub-elements, as discussed herein. The imaging sub-elements are based on CAPDs each having multiple outputs.

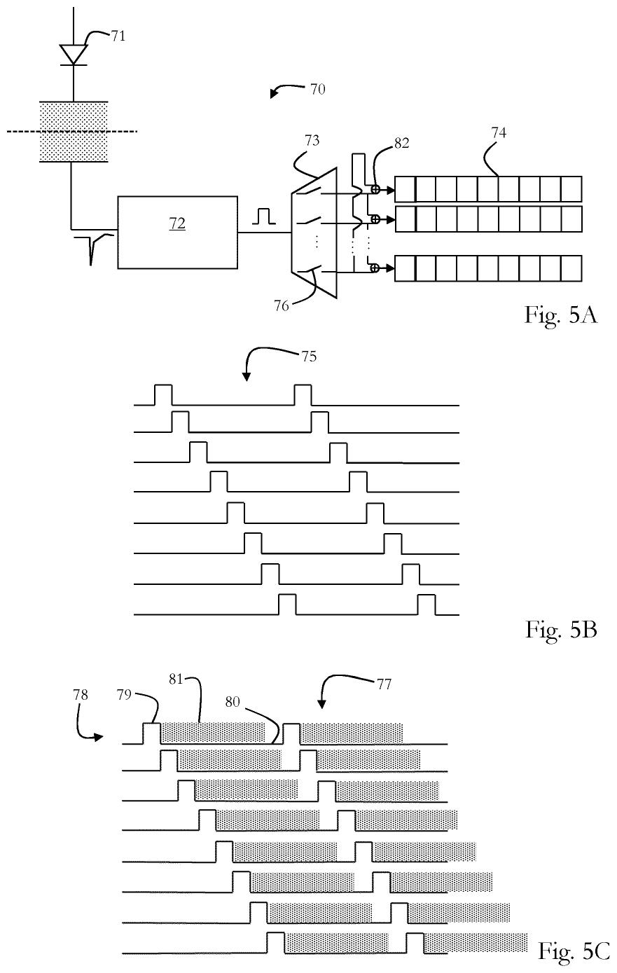

FIG. 7 depicts a further embodiment of a ToF readout method 95 according to the present disclosure, in which the plurality of time-shifted readout taps is applied to a plurality of capacitances of an imaging element.

Thus, at 92, a plurality of time-shifted readout taps is applied to a plurality of capacitances, as discussed herein, such as in the embodiment of FIG. 3

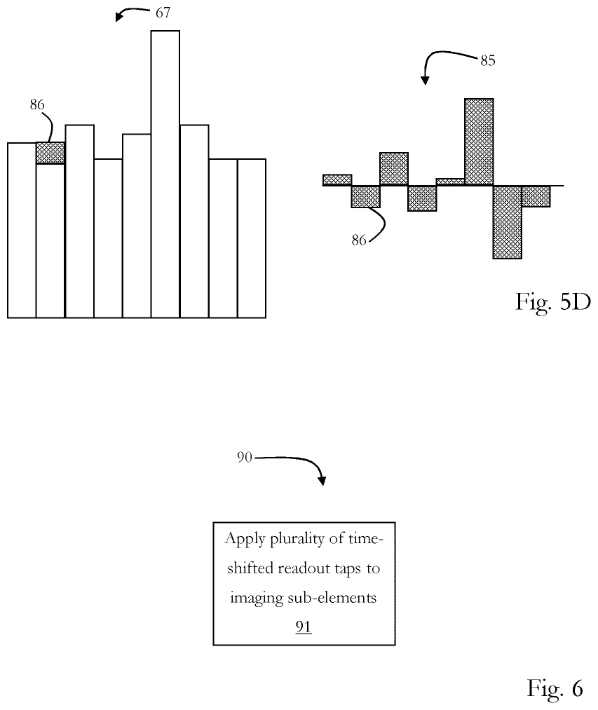

FIG. 8 depicts a further embodiment of a ToF readout method 100 according to the present disclosure, in which the plurality of time shifted readout taps is applied to a plurality of counters.

Accordingly, at 101, a plurality of time-shifted readout taps is applied to a plurality of counters, which are, in this embodiment, bidirectional counters, such as discussed under reference of FIG. 5.

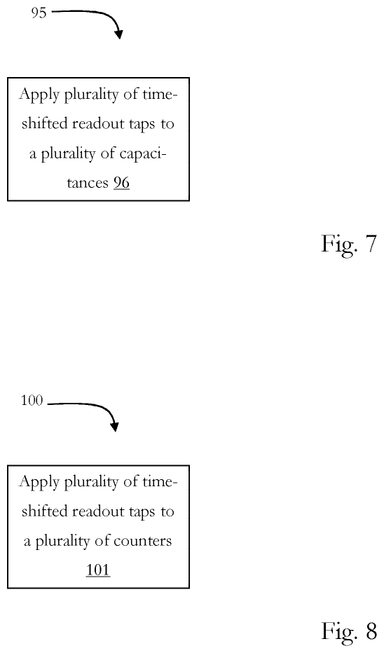

FIG. 9 depicts a further embodiment of a ToF readout method 105 according to the present disclosure, in which a histogram is generated based on the plurality of counters.

At 106, a plurality of time-shifted readout taps is applied to a plurality of bidirectional counters, as discussed herein.

At 107, a delta histogram is generated, as discussed herein.

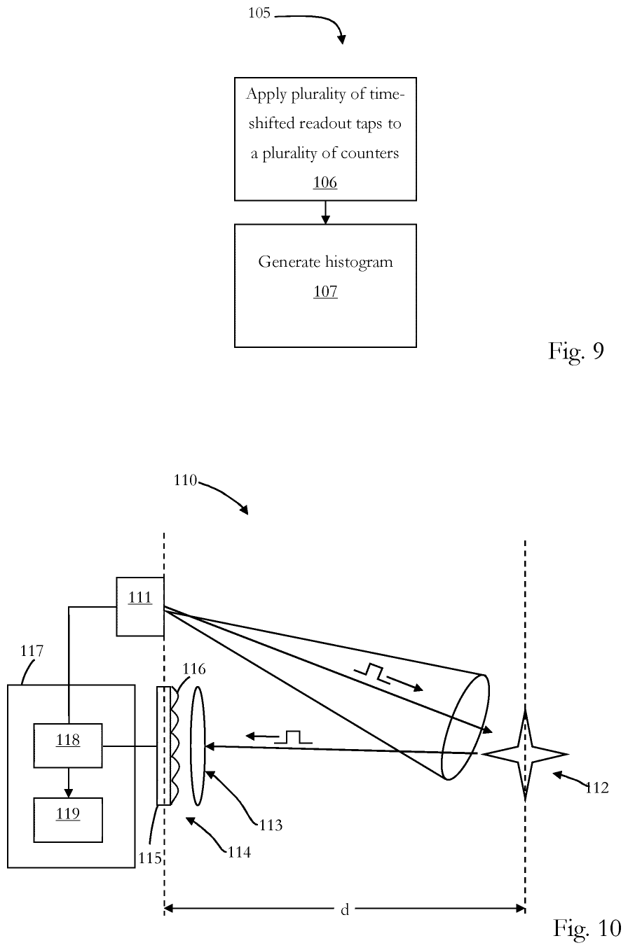

In FIG. 10, on a high level, there is illustrated an embodiment of a time-of-flight imaging system 110, which is embodied here as a ToF camera and which can be used for depth sensing or providing a distance measurement and which includes time-of-flight light circuitry 117 which is configured to perform the methods as discussed herein and which forms a control of the ToF apparatus 110 (and it includes, not shown, corresponding processors, memory and storage as it is generally known to the skilled person).

The ToF imaging system 110 has a pulsed light source 111 and it includes light emitting elements (based on laser diodes), wherein in the present embodiment, the light emitting elements are narrow band laser elements.

The light source 111 emits pulsed light to a scene 112 (region of interest or object), which reflects the light. By repeatedly emitting light to the scene 112, the scene 112 can be scanned, as it is generally known to the skilled person. The reflected light is focused by an optical stack 113 to a light detector 114.

The time-of-flight light circuitry 117 also forms control of the light source, such that it also includes a corresponding control circuitry (not depicted).

The light detector 114 includes an image sensor 115, which is implemented based on multiple SPADs (Single Photon Avalanche Diodes) formed in an array of pixels (imaging elements) and a microlens array 116 which focuses the light reflected from the scene 112 to the image sensor 115 (to each pixel of the image sensor 115).

The light emission time information is fed from the light source 111 to the time-of-flight light circuitry 117 including time-of-flight readout circuitry 118, which also receives respective time information from the image sensor 115, when the light is detected which is reflected from the scene 112. On the basis of the emission time information received from the light source 111 and the time of arrival information received from the image sensor 115, the time-of-flight readout circuitry 118 computes a round-trip time of the light emitted from the light source 111 and reflected by the scene 112 and on the basis thereon it computes a distance d (depth information) between the image sensor 115 and the scene 112.

The depth information is fed from the time-of-flight measurement unit 118 to a 3D image reconstruction unit 119 of the time-of-flight light circuitry 117, which reconstructs (generates) a 3D image of the scene 112, based on the depth information received from the time-of-flight measurement unit 118.

Please note that the division of the ToF circuitry 117 into units 118 and 119 is only made for illustration purposes and that the present disclosure is not limited to any specific division of functions in specific units. For instance, the ToF circuitry 117 could be implemented by a respective programmed processor, field programmable gate array (FPGA) and the like.

The methods discussed herein can also be implemented as a computer program causing a computer and/or a processor to perform the methods, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software. In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) Time-of-flight circuitry comprising:
an imaging element; and
readout circuitry configured to:
apply a plurality of time-shifted readout taps to a plurality of outputs of the imaging element, wherein the time-shifted readout taps are shifted in time with respect to each other, such that the outputs of the imaging element are read out after one another.

(2) The time-of-flight circuitry of (1), wherein the imaging element includes a plurality of imaging sub-elements.

(3) The time-of-flight circuitry of (2), wherein each sub-element includes at least one output.

(4) The time-of-flight circuitry of (1), wherein the plurality of outputs corresponds to a plurality of capacitances of the imaging element.

(5) The time-of-flight circuitry of (4), wherein the plurality of time-shifted readout taps is applied to the plurality of capacitances based on a main readout capacitance to which each time-shifted readout signal is applied, and based on a plurality of sub-capacitances which each are read out with one respective time-shifted readout signal of the plurality of time-shifted readout signals.

(6) The time-of-flight circuitry of (4) or (5), wherein each capacitance is coupled to at least two readout switches.

(7) The time-of-flight circuitry of (1), wherein the plurality of outputs corresponds to a plurality of counters.

(8) The time-of-flight circuitry of (7), wherein a histogram is generated based on counts in the plurality of counters.

(9) The time-of-flight circuitry of (7) or (8), wherein the counters are bidirectional counters.

(10) The time-of-flight circuitry of (9), wherein a histogram is generated based on counts in the bidirectional counters, wherein entries of the histogram correspond to relative counts with respect to their respective neighboring entry.

(11) A time-of-flight readout method comprising:
applying a plurality of time-shifted readout taps to a plurality of outputs of an imaging element, wherein the time-shifted readout taps are shifted in time with respect to each other, such that the outputs of the imaging element are read out after one another.

(12) The time-of-flight readout method of (11), wherein the imaging element includes a plurality of imaging sub-elements.

(13) The time-of-flight readout method of (12), wherein each sub-element includes at least one output.

(14) The time-of-flight readout method of (11), wherein the plurality of outputs corresponds to a plurality of capacitances of the imaging element.

(15) The time-of-flight readout method of (14), wherein the plurality of time-shifted readout taps is applied to the plurality of capacitances based on a main readout capacitance to which each time-shifted readout signal is applied, and based on a plurality of sub-capacitances which each are read out with one respective time-shifted readout signal of the plurality of time-shifted readout signals.

(16) The time-of-flight readout method of (14) or (15), wherein each capacitance is coupled to at least two readout switches.

(17) The time-of-flight readout method of (11), wherein the plurality of outputs corresponds to a plurality of counters.

(18) The time-of-flight readout method of (17), wherein a histogram is generated based on counts in the plurality of counters.

(19) The time-of-flight readout method of (17) or (18), wherein the counters are bidirectional counters.

(20) The time-of-flight readout method of (19), wherein a histogram is generated based on counts in the bidirectional counters, wherein entries of the histogram correspond to relative counts with respect to their respective neighboring entry.

(21) A computer program comprising program code causing a computer to perform the method according to anyone of (11) to (20), when being carried out on a computer.

(22) A non-transitory computer-readable recording medium that stores therein a computer program product, which, when executed by a processor, causes the method according to anyone of (11) to (20) to be performed.

1. Time-of-flight circuitry comprising:
an imaging element; and
readout circuitry configured to:
apply a plurality of time-shifted readout taps to a plurality of outputs of the imaging element, wherein the time-shifted readout taps are shifted in time with respect to each other, such that the outputs of the imaging element are read out after one another.

2. The time-of-flight circuitry of claim 1, wherein the imaging element includes a plurality of imaging sub-elements.

3. The time-of-flight circuitry of claim 2, wherein each sub-element includes at least one output.

4. The time-of-flight circuitry of claim 1, wherein the plurality of outputs corresponds to a plurality of capacitances of the imaging element.

5. The time-of-flight circuitry of claim 4, wherein the plurality of time-shifted readout taps is applied to the plurality of capacitances based on a main readout capacitance to which each time-shifted readout signal is applied, and based on a plurality of sub-capacitances which each are read out with one respective time-shifted readout signal of the plurality of time-shifted readout signals.

6. The time-of-flight circuitry of claim 4, wherein each capacitance is coupled to at least two readout switches.

7. The time-of-flight circuitry of claim 1, wherein the plurality of outputs corresponds to a plurality of counters.

8. The time-of-flight circuitry of claim 7, wherein a histogram is generated based on counts in the plurality of counters.

9. The time-of-flight circuitry of claim 7, wherein the counters are bidirectional counters.

10. The time-of-flight circuitry of claim 9, wherein a histogram is generated based on counts in the bidirectional counters, wherein entries of the histogram correspond to relative counts with respect to their respective neighboring entry.

11. A time-of-flight readout method comprising:
applying a plurality of time-shifted readout taps to a plurality of outputs of an imaging element, wherein the time-shifted readout taps are shifted in time with respect to each other, such that the outputs of the imaging element are read out after one another.

12. The time-of-flight readout method of claim 11, wherein the imaging element includes a plurality of imaging sub-elements.

13. The time-of-flight readout method of claim 12, wherein each sub-element includes at least one output.

14. The time-of-flight readout method of claim 11, wherein the plurality of outputs corresponds to a plurality of capacitances of the imaging element.

15. The time-of-flight readout method of claim 14, wherein the plurality of time-shifted readout taps is applied to the plurality of capacitances based on a main readout capacitance to which each time-shifted readout signal is applied, and based on a plurality of sub-capacitances which each are read out with one respective time-shifted readout signal of the plurality of time-shifted readout signals.

16. The time-of-flight readout method of claim 14, wherein each capacitance is coupled to at least two readout switches.

17. The time-of-flight readout method of claim 11, wherein the plurality of outputs corresponds to a plurality of counters.

18. The time-of-flight readout method of claim 17, wherein a histogram is generated based on counts in the plurality of counters.

19. The time-of-flight readout method of claim 17, wherein the counters are bidirectional counters.

20. The time-of-flight readout method of claim 19, wherein a histogram is generated based on counts in the bidirectional counters, wherein entries of the histogram correspond to relative counts with respect to their respective neighboring entry.
